(19) United States
(12) Patent Application Publication
(10) Pub. No.: US 2023/0318074 A1
(43) Pub. Date: Oct. 5, 2023

(54) Electrical Conductor for Use in a Battery

(71) Applicant: Methode Electronics Malta Ltd., Birkirkara (MT)

(72) Inventors: Alexander Galea, Dingli (MT); Matthew Spiteri, Zejtun (MT)

(21) Appl. No.: 18/190,385

(22) Filed: Mar. 27, 2023

(30) Foreign Application Priority Data
Apr. 5, 2022 (DE) 102022108197.4

(51) Int. Cl. H01M 10/653; H01M 50/526; H01M 50/524; B32B 3/04; H01B 7/29

(52) U.S. Cl. CPC H01M 10/653; H01M 50/526; H01M 50/524; B32B 3/04; H01B 7/292; B32B 27/34

(57) ABSTRACT

An electrical conductor for use in a battery of an electrically powered motor vehicle has a busbar enclosed by a first layer. A second layer is placed on the side of the first layer facing away from the electrical conductor.

### RELATED APPLICATION DATA

This application claims priority benefit to German Patent Application Ser. No. 10 2022 108 197.4, filed Apr. 5, 2022, the disclosure of which is incorporated by reference herein.

### FIELD OF THE INVENTION

The invention refers to an electrical conductor for use in a battery.

### BACKGROUND

Electrically powered motor vehicles have become increasingly important in recent years. Consequently, many vehicle manufacturers are expanding their range to include such electric vehicles.

Such electrically powered vehicles often draw their drive energy from batteries.

In the course of this, the market for spare parts for electric vehicles is becoming increasingly important as well.

Due to the drive concept, electrically powered motor vehicles must meet different safety standards than motor vehicles with combustion engines.

Government regulations have followed the increasing demand for electrically powered vehicles imposing homologation requirements on the manufacturer of electric vehicles.

The invention understands the homologation requirements to be the process of certifying that a particular electrically powered motor vehicle is roadworthy and matches certain specified criteria laid out by the government for all vehicles made or imported into a specific country. The homologation requirements are meant to ensure the safety of the occupant of the electrically powered motor vehicle.

### Problem and Object of Invention

Among other regulations, the homologation requirements lead to the regulation that the electrically powered motor vehicle needs to ensure a number of safety requirements.

In the event of a thermal runaway in the battery compartment of the electrically powered motor vehicle, it shall be prevented in any case that the subsystems of the electrically powered motor vehicle fail to such an extent that the occupants in the passenger compartment of the vehicle are exposed to fire.

The risk of a fire due to thermal runaway in the battery of the electrically powered motor vehicle has prompted manufacturers of electrically powered motor vehicles to provide measures that eliminate or at least reduce the risk of an electrical short between conductors in the battery of the electrically powered motor vehicle due to melting and softening of insulating materials caused by the heat generated during such an event.

The measures may be arranged within a battery compartment or within the battery itself.

Known protection systems to avoid an electrical short in batteries frequently use a thermoplastic sheathing covering the electrical conductor.

However, due to the temperature ranges that occur during the thermal runaway, the thermoplastic sheathing of the protection system is not sufficient to protect the electrical conductor from short circuits.

Known thermoplastics will either melt or burn exposing the busbar to extreme heat, which will in turn cause a short circuit.

This leads to the aforementioned homologation regulations not being met. Serious injuries or death of the occupant of the vehicle may follow.

It is the objective of the invention to provide an electrical conductor, preferably a busbar, having a thermal insulation to protect the electrical conductor from extreme temperatures occurring during the thermal runaway.

It is a further object of the invention to provide an electrical conductor, preferably a busbar, that is inexpensive to manufacture. At the same time, an electrical conductor, preferably a busbar, should be improved in terms of productivity and quality.

### Solution to the Problem

The problem is solved by an electrical conductor for use in a battery of an electrically powered motor vehicle.

According to the invention the electrical conductor is a busbar.

The electrical conductor is enclosed by a first layer.

A second layer is placed on the side of the first layer facing away from the electrical conductor.

### Electrically Powered Motor Vehicle

Electrically powered motor vehicles can be equipped with a hybrid drive. The hybrid drive combines both an electric drive motor and a combustion drive engine in one vehicle.

Electrically powered motor vehicles may also derive their propulsion energy from hydrogen.

However, in the following the invention assumes that the electrically powered motor vehicle obtains its drive energy from a battery.

### Electrical Conductor

According to the invention the electrical conductor allows electric charges to easily flow through the electrical circuit.

The property of the electrical conductor to conduct electricity is referred to as conductivity.

The electrical conductor provides less resistance to the flow of electrical charges.

The electrical conductor is made of conducting materials that allows a free movement of electrical charges, preferably electrons, within the electrical circuit.

In the following, the invention refers to the electrical conductor as a busbar.

### Thermally Insulated Busbar

The invention understands the busbar to be a metallic strip or a metallic bar. The busbar allows electrical current to pass through the electrical circuit.

The busbar may typically be housed inside a switchgear and/or inside a panel board. The busbar may also be arranged inside a busway enclosure provided for a local high current power distribution. According to the invention, the busbar is arranged within a battery of an electrically powered vehicle.

According to the invention, the busbar may interconnect components or modules within the battery with each other. It may also interconnect components or modules within the battery compartment.

Preferably, the busbar is designed in a rectangular shape. It can also be designed with a round cross-section. The busbar may also have a circular cross section. Alternatively, the busbar may also have a rectangular section with rounded edges.

The invention refers to a busbar with the circular cross section to be a round busbar, wherein the busbar may be a wire.

It goes without saying that the busbar may also have another geometrical shape or a combination of various geometrical shapes.

The busbar may be manufactured from an extruded copper. The busbar may also be manufactured from a copper alloy or from an aluminium. Alternatively, an aluminium alloy may be used. It may also be manufactured from any other metal.

A common method of manufacturing busbars is to use co-extruded busbars. According to the invention, co-extruded means produced by simultaneous extrusion of multiple layers. Preferably, an extruded copper or aluminium wire having a square or a rectangular shape is coated with a thermoplastic material. The thermoplastic material may be at least one of a PA 12 (Polyamide 12) or a PA 11 (Polyamide 11) or a PVC (Polyvinyl Chloride) or a PEEK (Polyetherketoneketone). Derivatives of these can also be used.

To form the busbar, a continuous raw metal body is shaped into the desired geometric form. Computer-assisted and/or fully automated bending or cutting machines can be used for this purpose. The continuous raw metal body may be a straight body. Also, other manufacturing methods may be used. The cutting process and/or the bending process may also be referred to as a transformation process when manufacturing the thermally insulated busbar.

Preferably, the busbar is electrically insulated. The insulation prevents a short circuit between the busbar and neighbouring electrical components.

The thermal insulation of the busbar is ensured with the help of thermoplastic materials.

The thermoplastic material may comprise at least one of the following materials: PA (Polyamide), PBT (Polybutylene Terephthalate), PP (Polypropylene), PPA (Polyphthalamide) or PPS (Polyphenylene Sulfide). It goes without saying that other thermoplastic materials may also be used.

According to the invention the busbar ensures a sufficient insulation resistance when the busbar is exposed to an ambient temperature and/or flames between 500° C. and 1000° C.

The insulation resistance is ensured for a period of at least 10 minutes.

The invention provides the busbar with a thermal insulation coating. The thermal insulation coating is described in more detail below.

### Thermal Insulation Coating

The thermal insulation coating may be a multilayer coating. The thermal insulation coating comprises a first layer and a second layer. Both of which layers are referred to in more detail below.

### First Layer

The thermal insulation coating is a layer of material deposited onto a substrate. Preferably, the substrate is the busbar. The thermal insulation coating is applied to the busbar.

The thermal insulation coating improves the surface properties of the busbar for thermal insulation.

The thermal insulation coating comprises a first layer, also referred to as an inner layer.

The first layer is a high temperature electrically insulative layer.

The first layer is wrapped around the busbar. The first layer may also be wrapped and/or coated and/or sleeved around the electrical conductor. It goes without saying that the first layer may also be attached to the electrical conductor in another technical manner.

The first layer may be manufactured from various materials. The choice of materials for the production of the first layer depends on the maximum temperature that the thermal insulation coating must withstand.

Among other materials, the first layer may be manufactured from mica.

The first layer resists extremely high temperatures and/or flames during the event of a thermal runaway of the battery.

In addition, the first layer prevents the occurrence of short circuits in the battery. The melting or burning of the second layer (thermoplastic layer) can be effectively prevented by the arrangement of the first layer.

### Second Layer

Additionally, the thermal insulation coating comprises a second layer. The second layer is placed on the side of the first layer facing away from the busbar.

The second layer is also referred to as an outer layer.

The second layer is a thermoplastic layer. The thermoplastic layer may be nylon. It may also be manufactured from PEEK (Polyetherketoneketone). It goes without saying that the second layer may also be manufactured from at least one other material or a derivate thereof.

The second layer is extruded onto the first layer. The first layer is wrapped around the busbar. Preferably, the busbar is a continuous metal strip or a wire.

The second layer ensures that the first layer remains in position while the thermal insulation layer is applied to the busbar.

Additionally, the second layer protects a possibly fragile first layer during handling of the busbar. It also protects the fragile first layer during the forming process of the busbar and/or during the installation of the busbar in the electrically powered motor vehicle.

To protect the first layer, the second layer is designed as a flexible layer. Further, the second layer is designed to be mechanically rough in nature.

The second layer protects both the busbar and/or the first layer from damage during the transformation process when manufacturing the thermally insulated busbar.

### Battery

According to the invention the battery may be a collection of one or more battery cells. Inside the battery cell at least one chemical reaction creates a flow of electrons in an electrical circuit.

The battery may comprise one or more of the following components. The battery may comprise at least one anode and at least one cathode. The battery may also comprise an electrolyte. The electrolyte is a substance that chemically reacts with the anode and the cathode.

When the anode and the cathode of a battery is connected to an electrical circuit, a chemical reaction takes place between the anode and the electrolyte.

This reaction causes electrons to flow through the electrical circuit and back into the cathode where another chemical reaction takes place.

One of the most significant drawbacks of using a battery is that the battery cells arranged within the battery are required to be operated in a relatively narrow temperature range. The safety and stability of the battery depends on maintaining internal temperatures of the battery cells within specific temperature limits.

### Thermal Runaway in the Battery

The invention understands a thermal runaway in the battery of the electrically powered motor vehicle to be a chemical chain reaction within the at least one battery cell.

The chemical chain reaction may lead to extremely high temperatures that may cause a gassing of the battery cell. This may lead to a fire with temperatures which may be nearly impossible to extinguish.

In a thermal runaway, temperatures within the battery cell may rise within milliseconds.

If the temperature exceeds a critical limit a thermal runaway may occur. The thermal runaway may destroy the battery or, even worse, may start a fire.

In the battery of the electrically powered motor vehicle, the thermal runaway occurs when the temperature inside the battery cell reaches a point that causes a chemical chain reaction to occur inside the battery cell.

The chemical chain reaction inside the battery cell generates even more heat within the battery cell driving the temperature of the battery cell even higher. The increasing temperature causes further chemical chain reactions generating even more heat.

The chemical chain reaction inside the battery cell may create extremely high temperatures (around 752 degrees Fahrenheit/400 degrees Celsius).

The thermal runaway is very difficult to stop once it has started.

### DESCRIPTION OF THE DRAWING

FIG. 1 is a perspective view of an exemplary electrical conductor.

### DETAILED DESCRIPTION

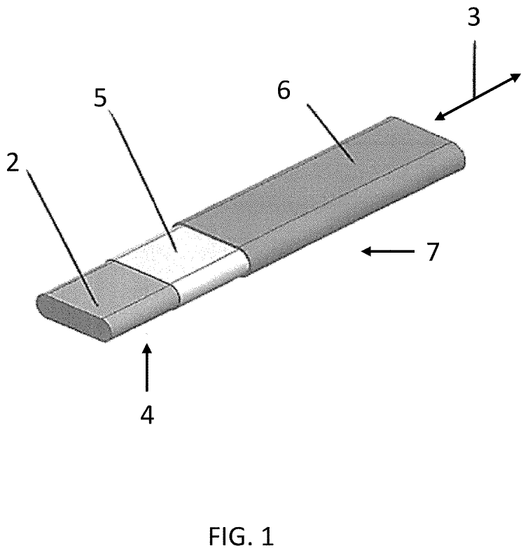

FIG. 1 shows an elongated electrical conductor 2. The electrical conductor 2 is designed as a thermally insulated busbar 1.

Along its longitudinal axis 3, the insulated busbar 1 has rounded edges 4.

A first layer 5 is wrapped around the insulated busbar 1.

On the side of the first layer 5 facing away from the insulated busbar 1, a second layer 6 is shown in FIG. 1.

So in FIG. 1, the busbar 1 is shown with a portion of the electrical conductor 2 exposed, and a first layer 5 exposed for ease of illustration.

### LIST OF REFERENCES

1 Busbar

2 Electrical conductor

3 Longitudinal axis

4 Edge

5 First layer

6 Second layer

1. An electrical conductor for use in a battery of an electrically powered motor vehicle, the electrical conductor comprising a busbar and being enclosed by a first layer, and a second layer being disposed on a side of the first layer facing away from the electrical conductor.

2. The electrical conductor according to claim 1 characterized in that the first layer is an electrically insulative layer.

3. The electrical conductor according to claim 1 characterized in that the first layer is wrapped around the electrical conductor.

4. The electrical conductor according to claim 1 characterized in that the first layer is coated around the electrical conductor.

5. The electrical conductor according to claim 1 characterized in that the first layer is sleeved around the electrical conductor.

6. The Electrical conductor according to claim 1 characterized in that the first layer is taped around the electrical conductor.

7. The electrical conductor according to claim 1 characterized in that the second layer comprises at least one thermoplastic material.

8. The electrical conductor according to claim 1 characterized in that the second layer is extruded onto the first layer.
